(19) United States
(12) Patent Application Publication
(10) Pub. No.: US 2007/0006623 A1
(43) Pub. Date: Jan. 11, 2007

(54) Cylinder lock

(76) Inventors: Gunter Barrenberg, Velbert (DE); Matthias Low, Ratingen (DE)

Correspondence Address: FRIEDRICH KUEFFNER, 317 MADISON AVENUE, SUITE 910, NEW YORK, NY, 10017, US

(21) Appl. No.: 10/550,635

(22) PCT Filed: Oct. 28, 2004
(86) PCT No.: PCT/EP03/11941

§ 371 Date: Sep. 22, 2005

(30) Foreign Application Priority Data
Mar. 24, 2003 (DE) 103 13 125.6

(51) Int. Cl. E05B 29/04

(52) U.S. Cl. 70/492

(57) ABSTRACT

The cylinder lock is comprised of a cylinder housing (10.1) and of a cylinder core (20.1), which is mounted therein and which accommodates spring-loaded plate-shaped tumblers (31.1) that can be longitudinal placed therein. The plate longitudinal edges (30.1, 30.2) of the tumblers are then guided on guiding surfaces (21.1, 22.1) inside the cylinder core (20.1). The tumblers (31.1) have control edges (41.1) placed at defined heights (45). The aim of the invention is to render the cylinder lock not only burglar-proof, but to also ensure a reliable protection against the loss of tumblers. To this end, the invention firstly provides that a cam (36.1) having a least one pair of flanks (37.1, 38.1) is placed either on one plate longitudinal edge (30.1) of the tumblers (31.1) or on the guiding surface in the cylinder core facing said plate longitudinal edge. The invention also provides that a cutout (26.1) is made either on the cylinder core (20.1) next to its cavity (23.1) for tumbler (31.1) or the cutout is made on the tumbler itself on its plate longitudinal edge facing the cam. Said cutout has at least one pair of mating flanks (27.1, 28.1) and is opposite the cam-side flanks (37.1, 38.1). The flanks and mating flanks (27.1, 37.1) function as a stop and counter sop for concealing the actual position of the control edges. At the same time, at least one flank and mating flank (27.1, 37.1) provide for a protection against the loss of tumblers, which provides for a holding together of the modular unit, which consists of the spring-loaded (13.1) tumblers (31.1) and of the cylinder core (20.1), even when the modular unit is located outside of the cylinder housing (10.1).

The invention pertains to a lock cylinder of the type indicated in the introductory clause of claim 1. The lock cylinder consists of a cylinder housing and a cylinder core, rotatably supported in the housing. A key with a defined longitudinal key profile is assigned to the lock cylinder and can be inserted into the cylinder core to actuate it by rotation. A group of diametric shafts in the cylinder core are arranged in an axial row; the shafts hold plate-shaped tumblers, which can slide longitudinally inside the shafts under the guidance of their longitudinal edges. The tumblers are spring-loaded in one of their two directions of movement and have control edges at defined heights, these edges being designed in conformity with the longitudinal profile of the key. In the resting position, that is, when the key is not present in the core, the tumblers engage in a locking channel in the cylinder housing. When the key is inserted and again when it pulled out, the tumblers can escape temporarily into an escape channel of the cylinder housing, which is diametrically opposite the locking channel.

The cylinder housing has the job of keeping the spring-loaded tumblers in the cylinder core even when the associated key is not present in the core. When the cylinder core is outside the cylinder housing, however, and the key is not inserted in it, the spring-loading tries to push the tumblers out of the shafts in the cylinder core and can even catapult them completely out unless sufficient attention is paid. To prevent this, use is made of so-called “loss prevention” measures. These loss prevention measures are intended to keep the inserted tumblers temporarily in their shafts in the cylinder core despite the attempt of the spring-loading to push them out. The state of the art provides various solutions to this problem.

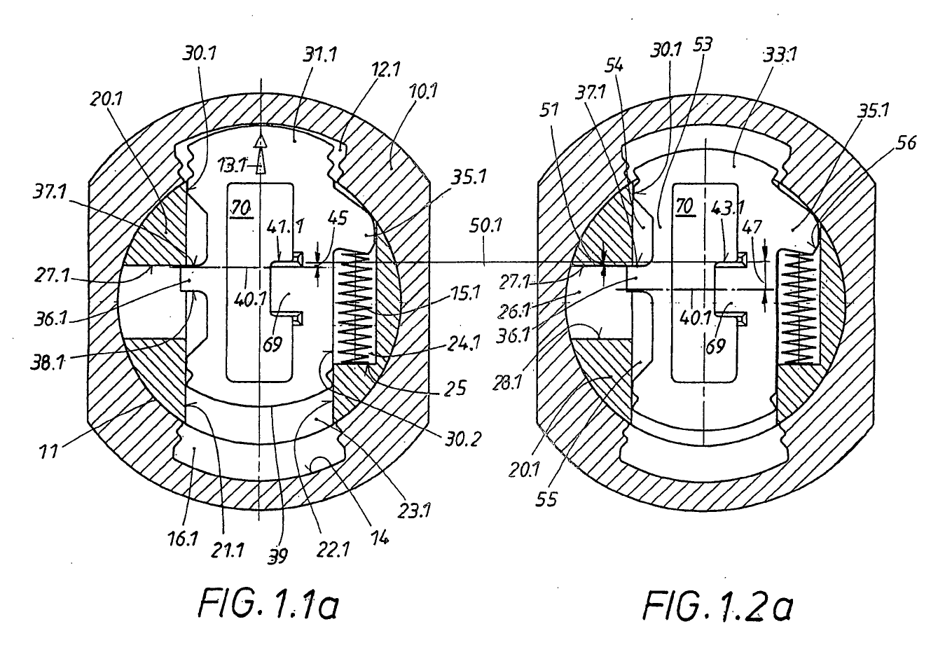

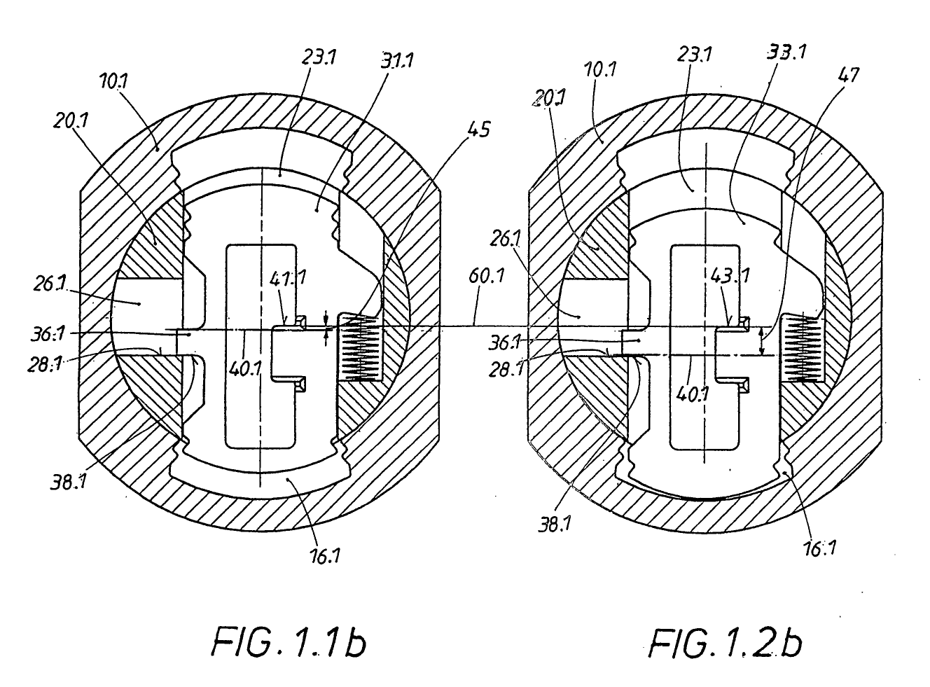

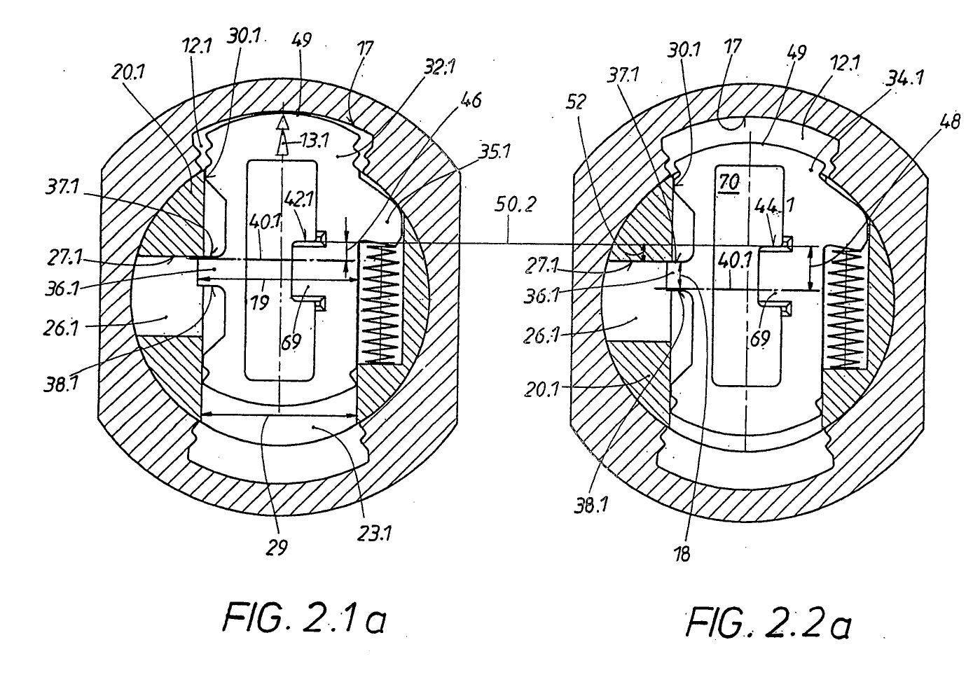

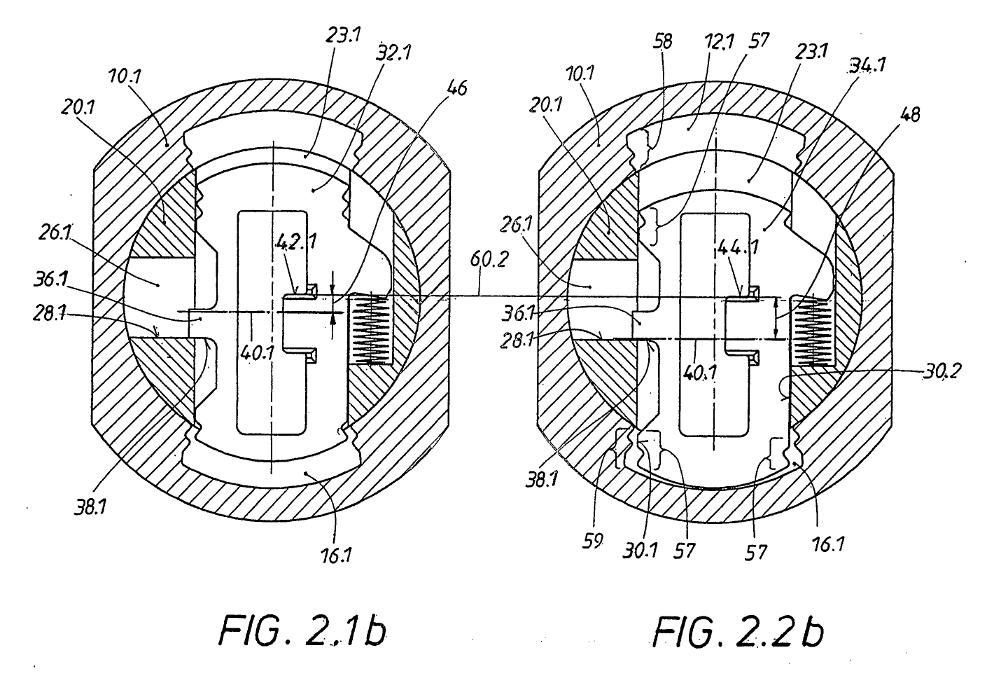

In the known lock cylinder of this type (GB 461,025 A), the lobes are formed by an inner edge of a continuous locking plate, which is inserted into a longitudinal slot in the cylinder core. The tumblers have lateral projections, which form a cutout between them, into which the inner edge of the inserted locking plate engages. As a result, the previously mentioned loss prevention is realized. This lock cylinder, however, is not resistant to manipulations by unauthorized persons. In the case of a similar lock cylinder (FR 2,033,437 A, FIGS. 1 and 2), it is known that the cutout can be made directly in one of the longitudinal plate edges of the tumbler. In both cases, however, unauthorized persons can detect the position of the control edges of the individual tumblers and thus make a copy of the key. These known lock cylinders are therefore not sufficiently pick-proof.

In the case of lock cylinders of a different type, in which the locking means are not mounted on the cylinder core until afterwards (FR 2,393,906 A), radial projections are produced in the interior of the shafts during the process by which the cylinder core itself is produced. These lock cylinders suffer from the disadvantage that these projections interfere with the installation of the tumblers. Nor are any measures taken to conceal the position of the control edges.

As previously mentioned, the security of a lock system depends on whether or not picking tools can be used to determine the position of each of the control edges on the individual tumblers. Unless special precautions are taken, the height of the control edges can be detected either directly by determining the resting position of the tumblers in the key channel or indirectly by determining the extent to which the individual tumblers can be pushed down against their spring-loading. In the latter case, a tool can be used to push the tumblers down one after the other into the escape channel against their spring-loading. In both cases, unauthorized persons can establish the longitudinal profile of the key and fabricate a copy on the basis of this knowledge.

To prevent this, the effort has been made to conceal the actual positions of the control edges on the tumblers by providing stops on the tumblers and opposing stops on the cylinder housing. In a known lock cylinder of this type (DE 28 15 380 C2), axially parallel longitudinal ribs are provided in the locking channel and in the escape channel of the cylinder housing, and the tumblers are provided on their terminal plate edges with cutouts of various depths. The depths of the cutouts are selected so that, for example, the control edges of the tumblers, which are at different heights, will all come to rest on the same height line in the resting state. The idea of positioning all the control edges at the same height was also used as a defense against the indirect picking method, according to which the tumblers are pushed back against their spring-loading into the escape channel by a picking tool. No measures are taken on this lock cylinder to prevent the loss of the tumblers.

In a lock cylinder of a different type (EP 0,045,089 A1), in which the tumblers are not spring-loaded, the longitudinal plate edges of the tumblers are provided with shoulders, and recesses are made in the guide surfaces of the shaft in the cylinder core. The cylinder core of this lock cylinder must consist of two halves, so that the tumblers with their shoulders on both sides can be installed before the halves are put together. Only after the tumblers are installed can the two halves of the core be connected to each other by pins. This is disadvantageous.

A system of loss prevention has also been used in lock cylinders which have no radial opening for the radial insertion of the locking means. Thus a lock cylinder is known (EP 0,063,223 A1) in which an axial groove is provided in the interior of the cylinder core. This groove intersects all the shafts which hold the tumblers, so that a continuous bar can be inserted through it. The bar projects out from the longitudinal guide surfaces of the shaft and engages in one of two cutouts, which are cut into the two longitudinal plate edges of the tumblers. In another case (EP 0,879,927 A1), a bar of elastic material is used, which forms a group of elastic tongues at its inner end. When the elastic bar is inserted into an inner groove in the cylinder core, the tongues come to rest elastically against the tumblers. The idea here is to prevent the tumblers from rattling in the cylinder core. In neither case are any measures taken to conceal the position of the control edges.

To facilitate the installation of the tumblers, one of the longitudinal plate edges of the tumbler is provided with elastic tongues (FR 1,569,025 A), which serve a loss-prevention function. After installation, these tongues snap into a recess in the guide surface of their associated shaft. The flexible tongues made it easier to insert the tumblers into the cylinder core, but nothing is done to conceal the position of the control edges.

Finally, a loss-prevention measure for facilitating the installation of the tumblers is known (DE 1,955,108 A) in which a stop edge is produced on the tumbler by making a cutout in one of the longitudinal plate edges of the tumbler. An opposing shoulder in one of the offset guide surfaces of the shaft in the cylinder core is assigned to this stop edge. It is then possible for a machine to install the tumblers by tipping them: first the stop edge is pushed past the opposing shoulder, and then the tumbler is rotated to align it with the shaft. It is not possible to conceal the position of the control edges in this lock cylinder.

In summary, it can be concluded that, according to the state of the art as it pertains to the concealment of the positions of the control edges and the prevention of the loss of the tumblers during the assembly of the cylinder core, separate measures are required for each of the two functions and that, for the following reason, these functions could not be combined with each other. The means required for concealment had to be located between the cylinder housing and the tumbler, whereas the securing means for preventing the loss of the tumblers had to be located between the tumblers and the cylinder core. In the known lock cylinders with loss prevention, furthermore, it was difficult to install the tumblers unless the securing means were not introduced into the interior of the cylinder core until after the insertion of the tumblers.

The invention is based on the task of developing a simple, low-cost lock cylinder of the type indicated in the introductory clause of claim 1 in which the tumblers can be easily installed and which has a reliable system of loss prevention but which is also impossible to pick open because of the concealment of the position of the control edges. This is accomplished according to the invention by the measures cited in claim 1, to which the following special meaning attaches.

As a result of the comb which is inserted into the cylinder core, the teeth of the comb produce profiles at one end with at least one pair of oppositely-facing flanks, which are referred to in brief below as the “flank pair”. At least one pair of opposing flanks in the cutouts of the individual tumblers, which are to be referred to below as the “opposing flank pair”, is assigned to the first flank pair. The flank pairs and the opposing flank pairs are arranged in such a way that, after the comb has been inserted into the cylinder core and the key has been withdrawn, the control edges of at least two tumblers are at the same height, which means that the positions of the control edges are concealed, and it is impossible to identify the types of tumblers which are present. In contrast to the state of the art, the cylinder housing does not participate in the concealment of the positions of the control edges; all this is done in the invention by the cylinder, in which the comb has been inserted, and by the cutouts in the tumblers. In the invention, the cylinder housing can therefore be designed neutrally. Because of this concealment, unauthorized persons cannot identify the actual positions which the control edges of the individual tumblers occupy. As a result, these unauthorized persons cannot produce a copy of the key with which it would be possible to actuate the lock cylinder successfully.

There are two possible situations in which an unauthorized person can observe the tumblers; the concealment provided here operates in both. In the first situation, the spring-loaded tumblers are in the resting state, in which one of the flanks is resting against one of the opposing flanks. The other situation is present in an actuated position, which the unauthorized person has created by using a lock-picking tool to push the tumblers down as far as possible. In this second situation, the other flank of the tooth meets the other opposing flank of the recess.

Additional measures and advantages of the invention can be derived from the subclaims, from the following description, and from the drawings. The drawings show two exemplary embodiments of the invention. In the first exemplary embodiment, six different cross-sectional views through an inventive lock cylinder are shown:

FIGS. 1.1a-2.3a show cross-sectional views through the lock cylinder in its resting position in the area of six tumblers, the control edges of which are at a different heights;

FIGS. 1.1b-2.2b show the same cross-sectional views of the same lock cylinder after the tumblers have been pushed down as far as possible into the escape channel.

An exemplary embodiment of a second lock cylinder representing a modification of the preceding case is illustrated in the following figures:

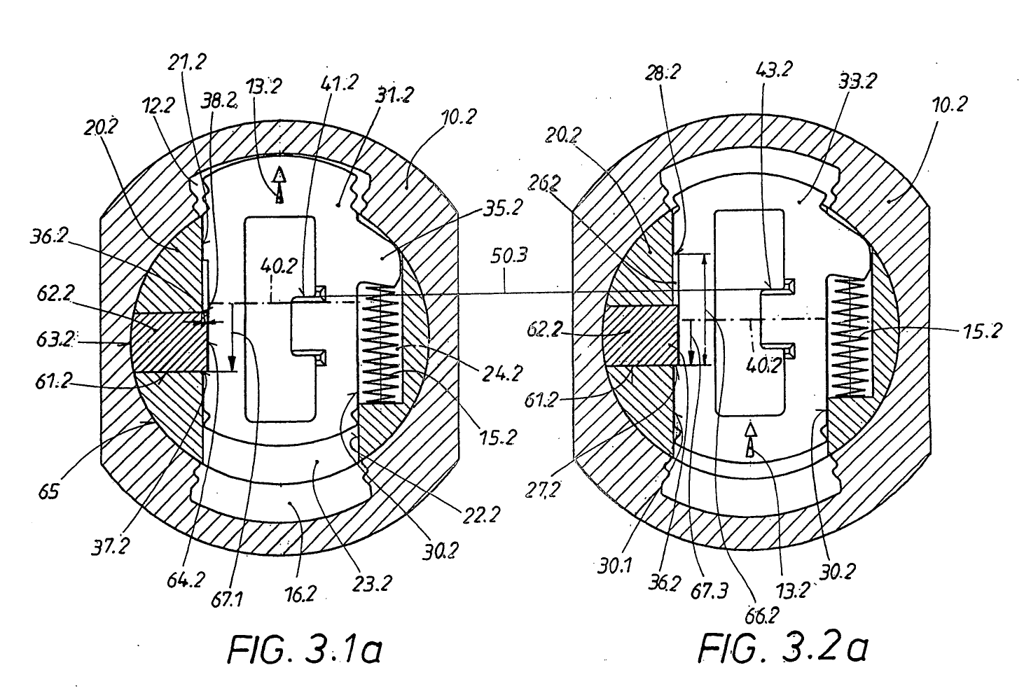

FIG. 3 shows a highly magnified, perspective view of a comb which can be inserted into the cylinder core of a second lock cylinder (not shown), only two tumblers, the control edges of the which are at the same height, being visible;

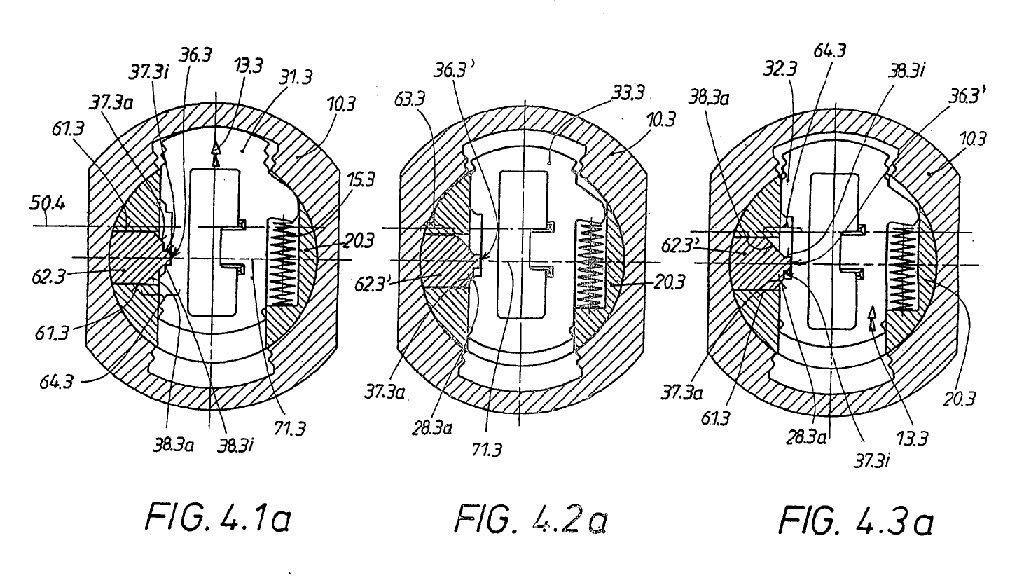

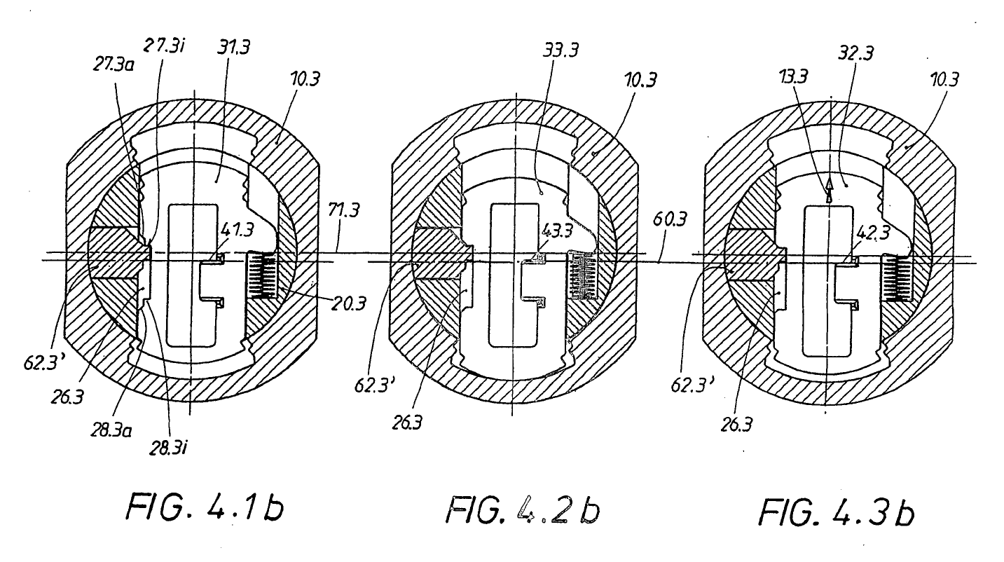

FIGS. 4.1a-4.4a, in analogy to FIGS. 1.1a to 2.3a, show eight cross-sectional views through a second lock cylinder in its rest position in the area of eight tumblers, some of the control edges of which are at different heights; and finally

FIGS. 4.1b-4.4b show the corresponding cross-sectional views of second lock cylinder after, in analogy to FIGS. 1.1b to 2.3b, the tumblers have been pushed down as far as possible.

The lock cylinder shown in FIGS. 1.1a-2.3a comprises a cylinder housing 10.3 with a bearing bore 11 for a cylinder core 20.3. The cylinder core 20.3 has a group of diametric shafts 23.31, arranged in a row, one behind the other, in each of which one of four different plate-shaped tumblers 31.3-34.4 is held. The longitudinal plate edges 30.1, 30.2, which are profiled in a particular way here as can be seen in FIG. 2.2a, are guided along appropriate guide surfaces 21, 22 of the shaft 23.3, these guide surfaces being located on the inner, narrow sides of the shaft 31.3. Each of the shafts 23.3 is provided in the conventional manner with an expansion 24 as can be seen in FIG. 2.3a, in which a compression spring 15.3 is located. One end of the compression spring 15.3 is supported against an end surface 25 of the expansion 24, whereas the opposite end grips a projection 35, which extends outward from the longitudinal plate edge 30.1 present there and into the expansion 24 of the shaft. As a result, the tumblers 31.3-34.3 are spring-loaded in the direction indicated by the force arrow 13.3.

The tumblers 31.3-34.3 have control edges 41.1-44.1, which can be at four different heights with respect to the height center line of the associated tumbler 31.3-34.3. In FIG. 1.1a, the control edge 41.3 is located at a first step height. The control edge 42.2 in FIG. 1.3a is at a second step height, whereas the control edge 43.3 in FIG. 1.2a is at a third step height. Finally, the control edge 44.3 of FIG. 2.1a is at a fourth step height. The control edges 41.3-44.1 in the present exemplary embodiment are located on a tongue 69, which projects into a window 70 in the associated tumbler 31.3-34.3, as can be seen in FIGS. 2.1a. The edge of the tongue 69 which serves as the control edge 41.3-44.4 is that which faces in the direction of the spring-loading 13.3.

The assigned key (not shown) has a flat profile, which matches the open width of the previously mentioned window 70 in the tumbler 31.1. The reason for the previously mentioned design of the control edge is that the flat key has its analogous opposing control edges on one or on both of its wide sides. These opposing control edges along the lateral control face of the key determine its individual longitudinal profile. When the tumblers 31.3-34.3 are to be installed in the successive shafts 23.3 of the cylinder core 20.3, as will be described in greater detail below, the tumblers 31.3-34.3 are selected and arranged in sequence in accordance with the opposing control edges of the longitudinal profile of the associated key.

Without the special inventive measures to be cited further below, the tumblers 31.3-34.3, because of their spring-loading 13.3, would all travel the same distance into the locking channel 12 provided in the cylinder housing 10.3 according to FIG. 1.2a when in the rest position, that is, after the key has been withdrawn. The insertion depth is determined by means familiar from the state of the art, such as by the contact of the spring-supporting projection 35.3 against the expansion 24 of the shaft 23.3. In this case, however, it is possible to insert a feeler into the key channel up to the individual windows 70 of the tumblers 31.3-34.3, to detect the positions of the control edges 41.3-44.3, and to use this knowledge to produce an unauthorized copy. This would put the security of the lock cylinder at risk.

Another possibility of a similar type of unauthorized detection process would be to insert a lock-picking tool into the windows 70 of the various tumblers 31.3-34.3 and to push the control edges 41.3-44.3 down so far in the direction of the arrows 77 of FIGS. 1.1b-2.3b that the terminal plate edge 39 of the tumblers in question meet the bottom surface 14 of the escape channel 16, shown in FIG. 1.1b. The escape channel 16 is located in the cylinder housing 10.3 diametrically opposite the locking channel 12. The escape channel 16 normally serves to allow the tumblers 31.3-34.3 to move out of the way when the key is being inserted. With the picking tool, the extent of the setback movement 77 of the individual tumblers could be determined in this case, whereupon it would be possible to determine the height of the control edges 41.3-44.3 on the individual tumblers 31.3-34.3. This could be used to produce an unauthorized copy. All this is prevented according to the invention for the following reason.

An insert 62.3 is used, which can be inserted through a radial opening 61.3 in the cylinder core 20.3 As can be seen in an especially concrete manner on the basis of FIG. 3 of the second exemplary embodiment, this insert is designed as a comb-like body 32.3, which is referred to below in brief as the “comb”. This comb 62.3 has a plurality of teeth 36.3, 36.3′, which, as FIG. 1.1a illustrates, have a special convex profile pointing in the radial direction. With reference to the direction of longitudinal movement of the tumbler 31.3 shown here, there are several pairs of flanks at different heights on the teeth 36.3, 36.3′. In the present case, two pairs of flanks are produced, which, relative to the maximum point of the lobe, are to be referred to as the inner flank pair 37.3i, 38.3i and as the outer flank pair 37.3a, 38.3a. When the comb 62.3 is inserted, the teeth 36.3, 36.3′ project into the individual shafts 23.3 of the cylinder core 20.3. Although the teeth 36.3, 36.3′ all have the same profile, they are given two different orientations which are mirror images of each other, as can be seen on the basis of their profiles.

FIGS. 1.1a-2.3b show the finished lock cylinder, after the tumblers 31.3-34.3 have been introduced into the shafts 23.3 of the cylinder core 20.3 and then the comb 62.3 with its teeth 36.3, 36.3′ has been pushed into a radial opening 61.3 in the cylinder core 20.3. A transverse plane 71.3 passing through the cylinder axis is shown in broken line in FIGS. 1.1a-2.3b. This plane is transverse to the direction in which the spring-loading 13.3 acts. Here is where the centers of the maximum points of the profiles are located. The inner flank pair 37.3i, 38.3i is symmetric with respect to the transverse plane 71.3 and has flanks which are essentially parallel to this transverse plane 71.3. The outer flank pair 37.3a, 38.3a is asymmetric to the transverse plane 71.3 and forms a certain angle to it. In addition, the outer flank 37.3a is shorter than the other flank 38.3a.

This design has the result that the stops thus produced assume different positions when, as previously said, the positions of the teeth 36.3, 36.3′ are laterally reversed in the cylinder core 20.3. This can be seen on comparison of FIG. 1.1a with FIG. 1.3a. In FIG. 1.1a, the tooth 36.3 is in its normal position, which means that it can be called the “normal tooth”. Here the shorter flank 37.3a is facing in the direction of the spring-loading 13.3. In FIG. 1.3a, however, the tooth is in the laterally reversed position on the comb 62.3, for which reason this tooth 36.3′ is called the “reversed tooth”. Thus the previously mentioned inner and outer flanks of the reversed tooth 36.3′ have changed places. The shorter flank 37.3a is now facing in the direction opposite the spring-loading 13.3 in FIG. 1.3a. The two teeth 36.3, 36.3′ are laterally reversed with respect to the transverse plane 71.3.

Cutouts 26.3 are located in the longitudinal plate edges 30.2 of the tumblers 31.3-34.3, that is, on the edges facing away from the projection 35. The cutouts 36.3 are of similar design. As can be seen on the basis of FIGS. 1.1b-2.3b, however, the various cutouts differ in their dimensions from each other as a function of the position of the associated control edge 41.3-44.3, and they also occupy different height positions. Common to all, however, is that the cutouts 26.3 are designed with two steps and that they have two different pairs of opposing flanks at different depths of the cutout. On the lower step of the cutout 26.3, as can be seen in FIG. 1.1b, there is an inner pair 37.3i and 38.3i of opposing flanks on the interior facing surfaces. On the upper step, the interior surfaces of the cutout 26.3 have an outer pair of opposing flanks 27.3a and 28.3a. In the same way as explained for the teeth 36.3, 36.3′, the inner opposing flanks 27.3i, 28.3i are again designed differently from the outer flanks 27.3a, 28.3a. The inner opposing flanks 27.3i, 28.3i are essentially parallel to the previously mentioned transverse plane 21.3 of the cylinder core 20.3, whereas the outer flanks 37.3a, 38.3a are at a certain angle to that plane. In the present case, the two outer opposing flanks 37.3a, 38.3a are essentially mirror images of each other. These design measures lead to the following results.

As previously mentioned, FIGS. 1.1a-2.3a show the rest position of the lock cylinder after the key has been removed. As a result, the flanks of the teeth 36.3, 36.3′ come to rest against the opposing stops of the opposing flanks of the cutout 26.3 in the tumbler. When the normal teeth 36.3 and the reversed teeth 36.3′ are positioned in the manner shown with respect to the tumblers in the cylinder core 20.3, the previously described control edges of the individual tumblers 31.3, 32.3, and 33.3 come to rest in the height position 50.4 according to FIGS. 1.1a-1.3a. The stop-counterstop action comes about then, according to FIG. 1.1a, through the interaction of the inner opposing flank 28.3i (see FIG. 1.1b) of the tumbler 31.3 with the flank 38.3i of the normal tooth 36.3. In contrast, in the case of the tumbler 32.3 according to FIG. 1.3a, the outer opposing flank 28.3a—because of the presence here of the reversed tooth 36.3′ on the comb 62.3—rests against the outer flank 37.3a, which is now facing in the direction away from the spring-loading 13.3. The same situation results in the case of the tumbler 33.3 in FIG. 1.2a.

As can be derived from FIGS. 2.2a and 2.3a, the two latter tumblers 32.3 and 33.3 can also be positioned in a different height position 50.5, which is in line with the control edge 42.3 of the fourth tumbler 34.3. This is so, because, in FIGS. 2.2a and 2.3a, the normal tooth 36.3 of the comb 32.3 is present, whereas, in the case of the tumbler 34.3 of FIG. 2.1a, a reversed tooth 36.3′ is used. Therefore, a different set of flanks and opposing flanks, namely, 38.3a and 28.3a, come to rest against each other in FIGS. 2.2a and 2.3a. In FIG. 2.1a, however, it is the inner opposing flank 28.3i of the tumbler 34.3 which rests against the inner flank 37.3i of the reversed tooth 36.3′.

As previously mentioned, FIGS. 1.1b-2.3b show positions analogous to those of FIGS. 1.1a-2.3a of the first exemplary embodiment after a lock-picking tool has been used to push the tumblers 31.3-34.3 down as far as possible in the direction of the previously mentioned setback arrow 77. The tool presses the tumblers 31.3-34.3 down against their spring-loading 13.3. Then the stops go into action again, and depending on whether at this point a normal tooth 36.3 or a reversed tooth 36.3′ is present, they bring the associated control edges 41.3-44.3 either into the height position 60.3 or into the height position 60.4. That the positions of the tumblers 33.3 and 32.3 in FIGS. 1.2b and 2.2b are different from those they occupy in FIGS. 1.3b and 2.3b is again a function of whether at this point on the comb 62.3 a normal tooth 36.3 or a reversed tooth 36.3′ is present. The flanks and opposing flanks which go into action thus differ in the two cases

As previously mentioned, a comb, the appearance of which can best be seen in FIG. 3, is also used in the second exemplary embodiment. In this case, the corresponding reference numbers are used to designate analogous parts, with the difference that here most of the number are followed by “0.4”. Only the differences need to be discussed. The preceding description applies to all else.

As previously mentioned, FIG. 3 shows a comb 62.4 with teeth 36.4, 36.4′, the inner ends 64.4 of these teeth having the same profile. The teeth 36.4, 36.4′, however, are arranged here, too, in two different laterally reversed positions on the comb 62.4, namely, in an alternating sequence of normal teeth 36.4 and reversed teeth 36.4′. When the teeth are inserted, the comb 62.4 is handled as a single unit. The associated radial openings 61.4 in the cylinder core 20.4 for the comb 62.4 and its teeth are of a uniform design, as can be seen in FIGS. 4.1a-5.1a.

As a comparison between FIGS. 4.1a and 4.2a shows, the maximum point of the normal tooth 36.4 is at a distance 72 in the height direction from the transverse plane 71.4 of the cylinder core 20.4, this plane being drawn in broken line and having been already explained in conjunction with the first exemplary embodiment, whereas the maximum point of the reversed tooth 36.4′ is at a distance 72′ from than transverse plane 71.4. As can be seen in FIG. 3, the normal teeth 36.4 and the reversed teeth 36.4′ are positioned either at the upper end 73 or at the lower end 73′. As previously mentioned, the flanks of the normal teeth 36.4 and the reverse teeth 36.4′ are uniform in design, namely, in the form of a single pair of flanks, but the flanks on the reversed tooth 36.4′ are offset in the height direction from those on the normal tooth 36.4. With respect to the direction in which the spring-loading 13.4 acts on the tumbler, the normal tooth 36.4 has an upper outer flank 37.4 and an upper inner flank 38.4, whereas the reversed tooth 36.4′ has an lower outer flank 37.4′ and a lower inner flank 38.4′.

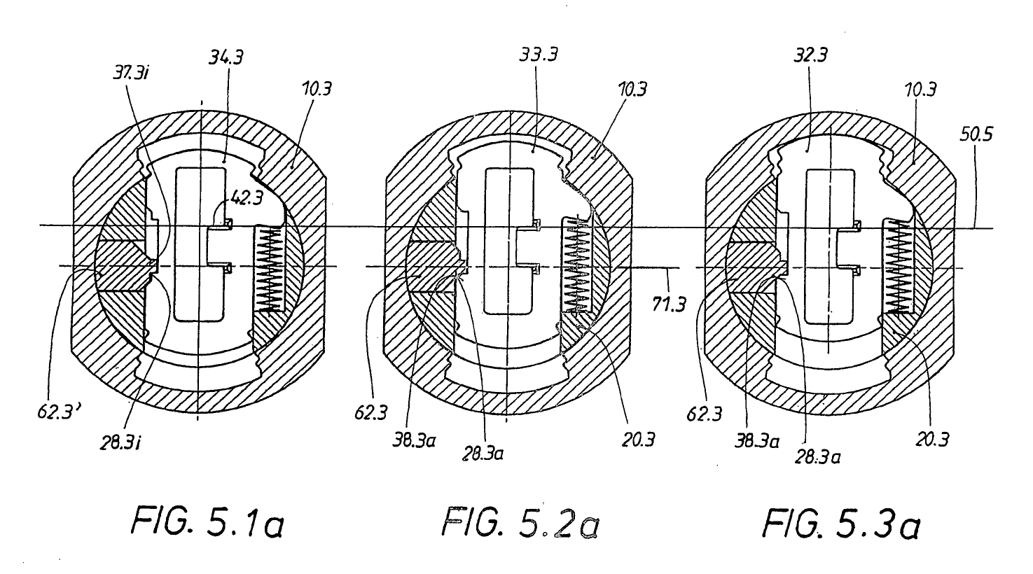

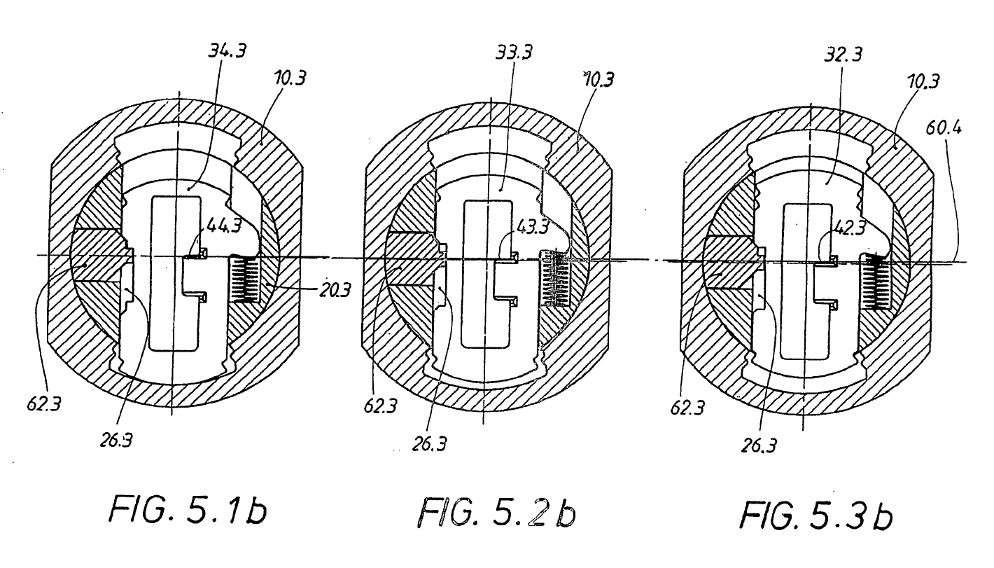

In the present case, the two flanks have different forms. As can be seen in FIG. 4.3a, the upper inner flank 38.4 is essentially parallel to the transverse plane 71.4 of the cylinder core 20.4, whereas the upper outer flank 37.4 is at a certain angle to that plane. This applies not only to the normal tooth 36.4 but also in analogous fashion to the reversed tooth 36.4′ according to FIG. 5.2a with respect to the corresponding lower outer flank 37.4′ and the lower inner flank 38.4′.

In the case of the second exemplary embodiment as well, the tumblers 31.4-34.4 again have the cutouts 26.4 with a very simple, symmetrical design. In the middle of each cutout 26.4 there is a separating web 74.1-74.4. Although the web is essentially in the middle of the cutout, its length in the direction in which the spring force 13.4 acts can be different from that of other webs in certain cases, depending on the position of the control edge 41.4-44.4. The profile is also simplified in the sense that, in the case of the tumblers 31.4 with the lowest control edge 41.1, the length of the separating webs 74.1 and 74.4 is the same as in the case of the tumbler 34.4, which has the highest control edge 44.4. In analogous fashion, the lengths of the separating webs 74.2 and 74.3 of the two tumblers 32.4 and 33.4, which have their control edges 42.4 and 43.4 in two different middle height positions, are also the same. Another variation of the profiling consists in that the bottom ends of the cutouts 26.4 begin at different distances 76.1-76.4 from the associated longitudinal midpoints 75.1-75.4 of the four different tumblers 31.4-34.4, as can be seen in FIGS. 4.1a, 4.3a, 4.4a, and 5.1a.

As can be derived from FIG. 5.3a, two pairs of opposing flanks are located in each cutout on the tumbler 32.4 with the separating web 74.2. The two flanks 27.4i, 28.4i of the one pair extend along the two edges of the separating web 74.2; because they are located at the inner ends of their respective cutouts, on the web, they are therefore called the “inner opposing flank pair”. The two other opposing flanks 27.4a and 28.4a are formed by the interior edges of the outer ends of their respective cutouts 26.4 and are therefore called the “outer opposing flank pair”. The inner opposing flanks 27.4i and 28.4i face away from each other, whereas the outer opposing flanks 27.4a and 28.4a face each other. In this case, too, the inner flanks 27.4i and 28.4i are essentially parallel to the transverse plane 71.4, whereas the outer flanks 27.4a and 28.4a are at an angle to this plane and are designed essentially as mirror images of each other.

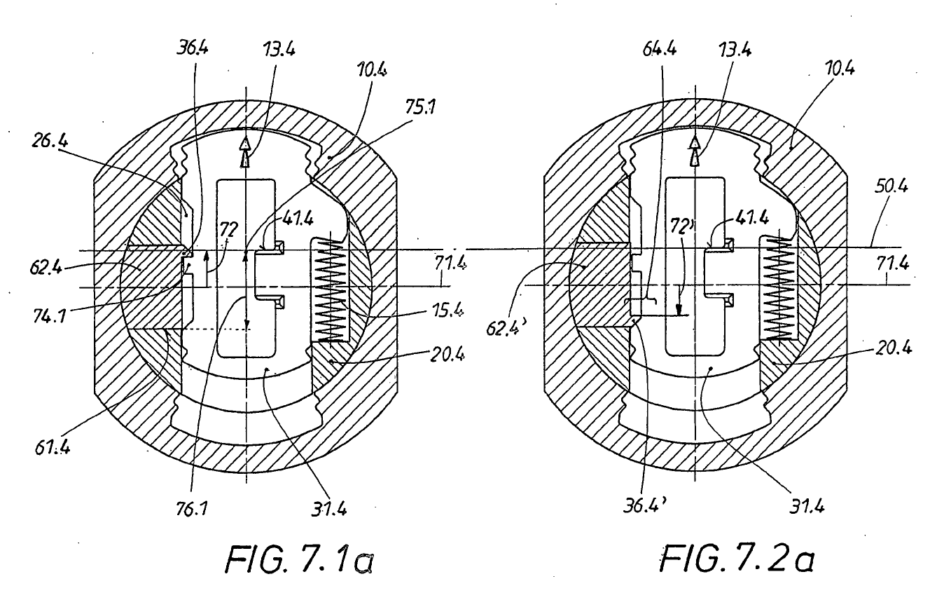

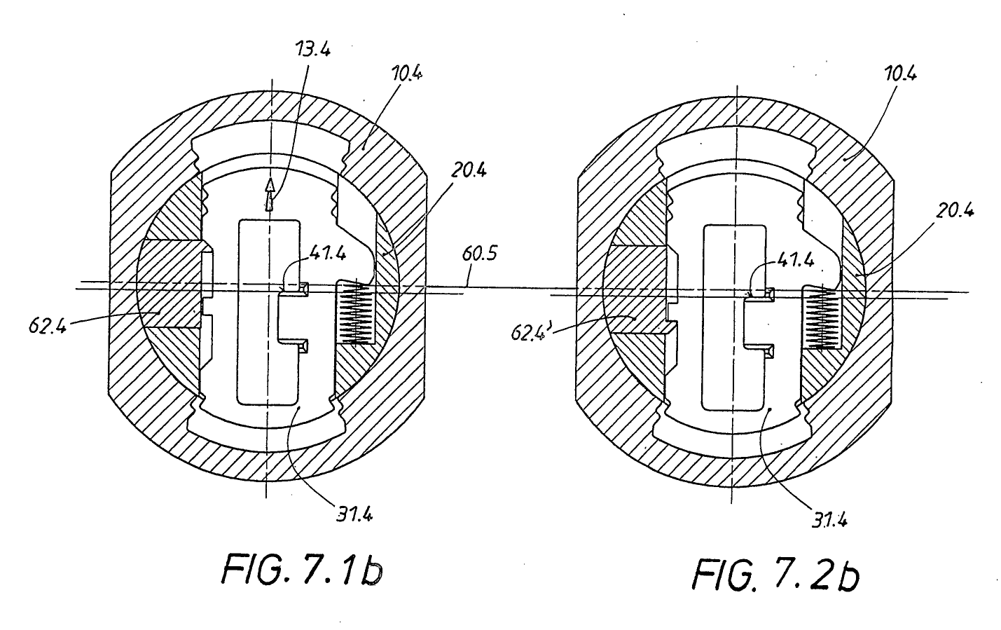

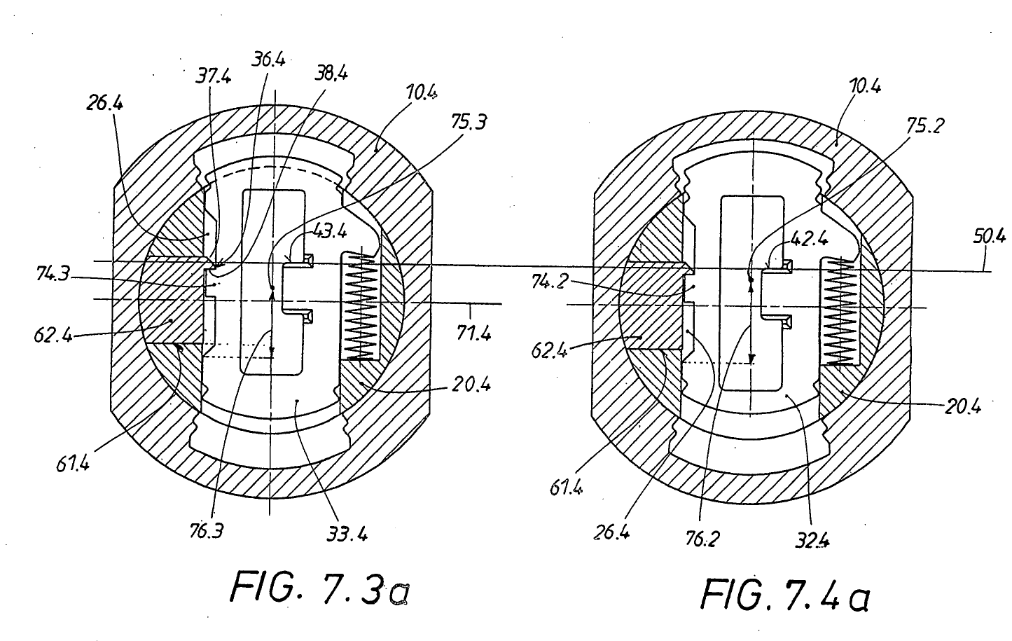

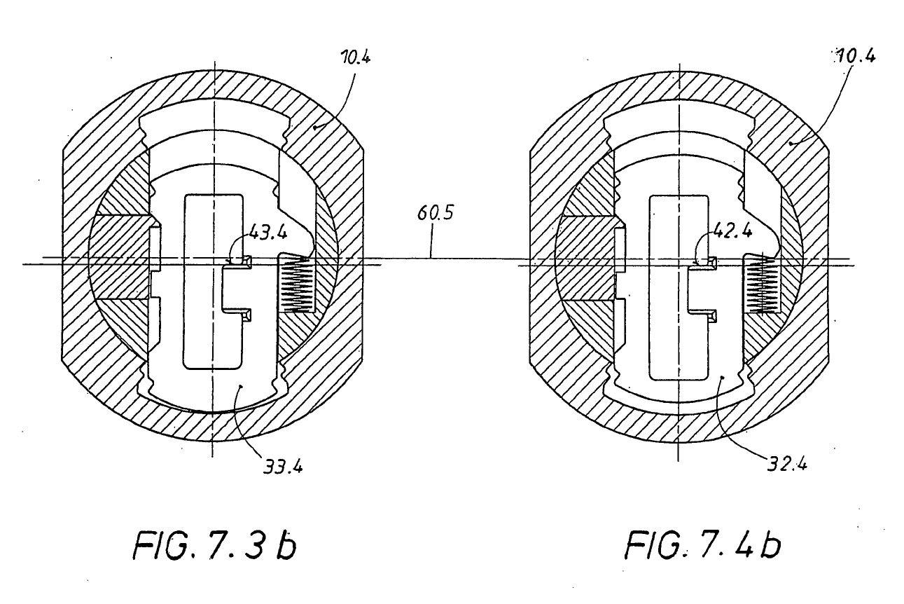

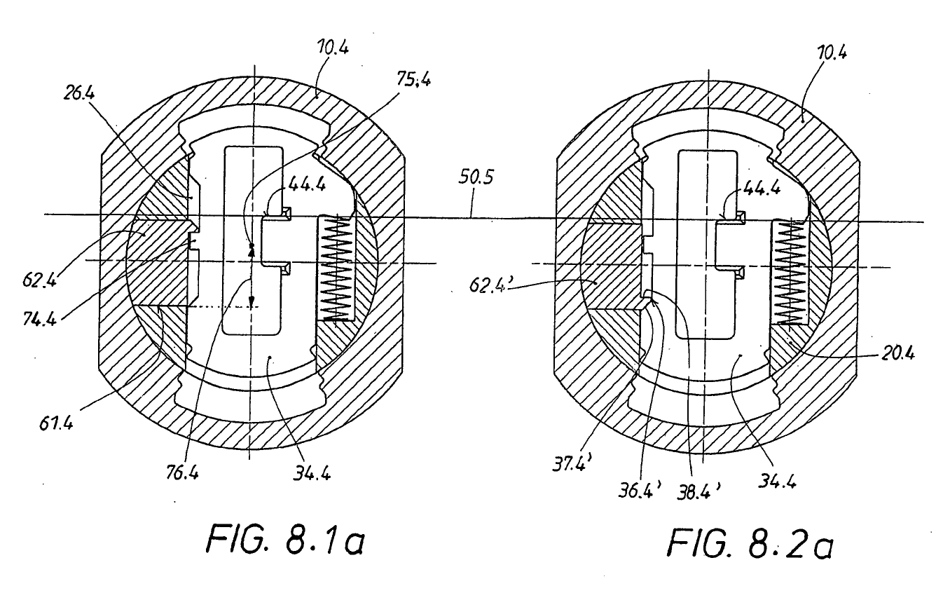

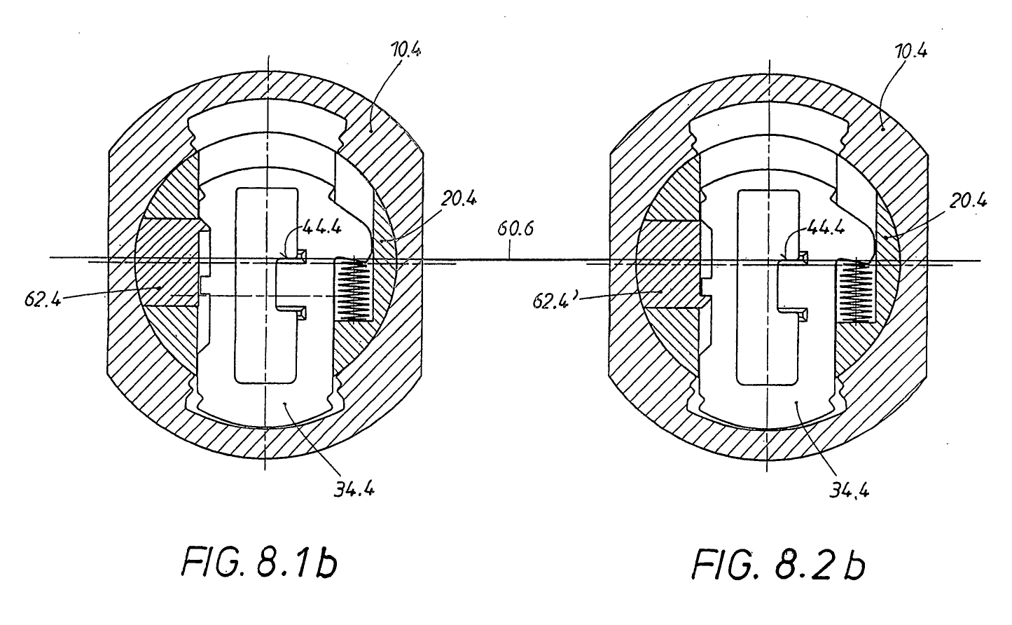

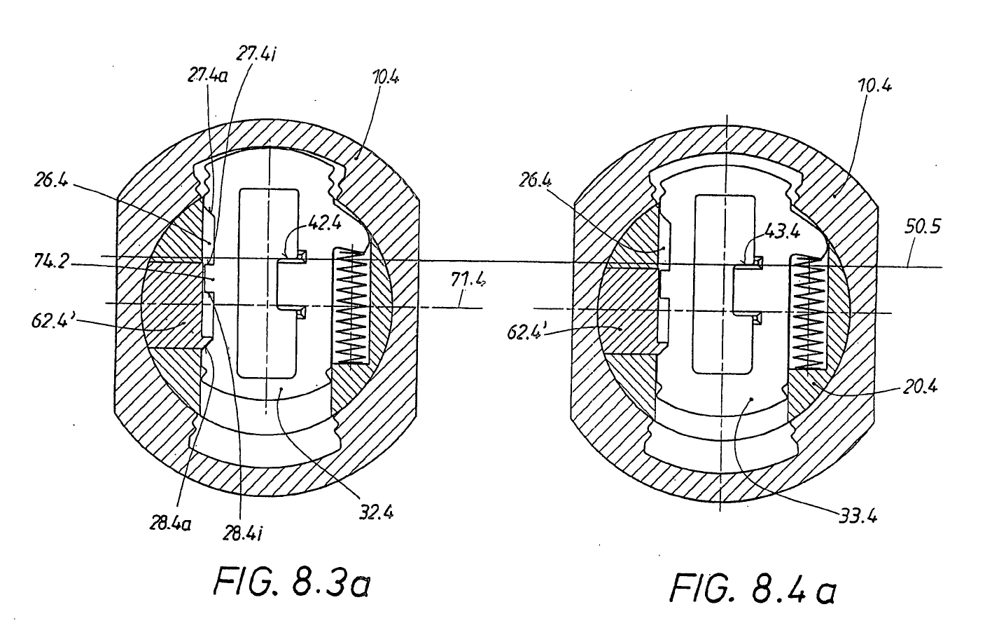

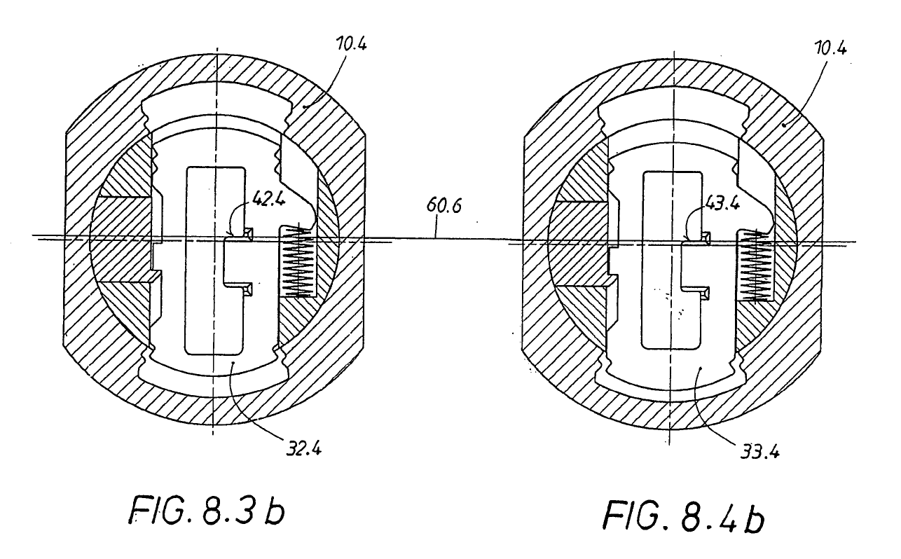

FIGS. 4.1a-5.4a show the relationships which exist in the resting state. In FIGS. 7.1a-7.4a, the control edges 41.4, 42.4, and 43.4 of the tumblers 31.4, 32.4, and 33.4 occupy a uniform height position in the cylinder housing 10.4 marked by the line 50.4. This applies initially for those tumbler locations at which a normal tooth 36.4 has been inserted into the cylinder core 20.4. But even when a reversed tooth 36.4′ is used, as shown in FIG. 4.2a, the control edge 41.4 of the tumbler 31.4 still remains at this same height position 50.4. The positions of the control edges 41.4-44.4 are therefore concealed in a highly effective way.

The same is true for the tumblers 32.4, 33.4, and 34.4 according to FIGS. 5.1a-5.4a, when the comb 62.4 has been inserted into the cylinder core 20.4. Now the associated control edges 42.4, 43.4, and 44.4 are in the height position designated 50.5. According to FIG. 5.1a, however, when a normal tooth 36.4 is used, the control edge 44.4 of the tumbler 34.4 is also at this same height 50.5. It is therefore impossible for an unauthorized person to tell which of the four possible tumblers 33.1-34.1 is present in any one of the locations in the cylinder housing 10.4. It is therefore impossible to make a copy of the key.

For the second exemplary embodiment as well, FIGS. 4.1b-5.4b show the relationships which result when the tumblers 31.4-44.4 are pushed down as far as possible by a lock-picking tool (not shown) in the direction of the motion arrow 77 against the spring-loading 13.4. In analogy to FIGS. 4.1a-4.4a, after the tumblers 31.4, 32.4, and 33.4 have been pushed down as shown by the arrow 77, the control edges 41.4, 42.4, and 43.4 are located in the same height position 60.5. The same is true, as shown in FIGS. 5.1b-5.4b, for the pushed-down tumblers 32.4, 33.4, and 34.4, where the control edges 44.4, 42.4, and 43.4 occupy the same height position 60.6. In this case, too, the pushed-down tumblers 31.4 in the one case and 34.4 in the other are each on the same height level 60.5, 60.6, regardless of whether a normal tooth 36.4 or a reversed tooth 36.4′ is present in the cylinder core 20.4. The actual positions 41.4-44.4 of the four tumblers 31.3-34.3 are thus concealed in the most effective way possible in each case.

In both embodiments, a set of different combs 62.3, 62.4 according to FIG. 3 can be assigned to a plurality of similar cylinder cores 10.3, 10.4 the teeth of these combs having different profiles “O” at their ends. This increases the number of possible lock cylinder variants, because any one of these different combs can be selected and inserted into one of these cylinder cores 20.3 or 20.4.

This also applies to the simple case explained for the second exemplary embodiment, where the combs have teeth with identical profiles, but where the normal teeth 36.4 and the reversed teeth 36.4′ are arranged in an alternating sequence along the comb 62.4. If an even number of teeth is used in the comb 62.4 to realize this principle, the key point is then to decide which end of the comb 62.4 is to be inserted first into the lock cylinder 20.4 of a uniform type. A normal tooth 36.4 will be at one end of the comb and a reversed tooth 36.4′ at the other end. As explained on the basis of FIGS. 4.1-5.4a, the four different tumblers 34.1-34.4 will then be at the same height positions 50.4 or 50.5. With minimal effort and with the simplest design, a maximum of concealment is obtained for the actual positions of the control edges 41.1-41.4 in the cylinder housing 10.4.

### LIST OF REFERENCE NUMBERS

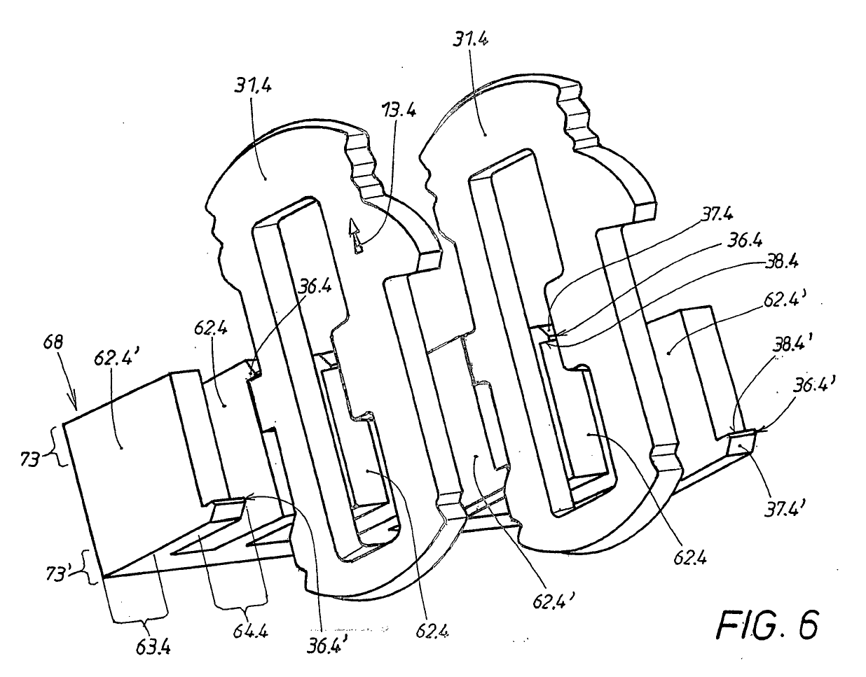

10.3 cylinder housing (FIGS. 1.1a-2.3b)
10.4 cylinder housing (FIGS. 4.1a-5.4a)
11 bearing bore in 10.1 (FIG. 1.2a)
12 locking channel in 10.1 (FIG. 1.2a)
13.3 force arrow of the spring loading (FIG. 1.1a)
14 force arrow of the spring loading (FIG. 4.1a)
14 bottom surface of 16.1 (FIG. 1.1b)
15.3 compression spring (FIG. 4.1a)
15.4 compression spring (FIG. 7.la)
16 escape channel in 10.1 (FIG. 1.1b)
17 bottom surface of 12 (FIG. 2.3a)
20.3 cylinder core (FIGS. 1.1a-2.3b)
20.4 cylinder core (FIGS. 4.1a-5.4a)
21 first guide surface for 30.3 (FIG. 2.2a)
22 second guide surface for 30.3 (FIG. 2.2a)
23.3 shaft in 20.3 (FIG. 1.2b)
23.4 shaft in 20.4 (FIG. 4.3b)
24 expansion of 23.3 (FIG. 2.3a)
25 end surface of 24.1 (FIG. 1.1a)
26.3 cutout in 31.3-34.3
26.4 cutout in 31.4-34.4
27.3a outer opposing flank of 26.3 (FIGS. 1.1a-2.3b)
27.3i inner opposing flank of 26.3 (FIGS. 1.1a-2.3b)
27.4a outer opposing flank of 26.4 (FIGS. 4.1a-5.4a)
27.4i inner opposing flank of 26.4 (FIGS. 4.1a-5.4a)
28.3a outer opposing flank of 26.3 (FIGS. 1.1a-2.3b)
28.3i inner opposing flank of 26.3 (FIGS. 1.1a-2.3b)
28.4a outer opposing flank of 26.4 (FIGS. 4.1a-5.4a)
28.4i inner opposing flank of 26.4 (FIGS. 4.1a-5.4a)
30.1 longitudinal plate edge of 31.3 facing 35 (FIG. 2.2a)
30.2 longitudinal plate edge of 31.3 facing away from 35 (FIG. 2.2a)
31.3 tumbler with 41.3 for 20.3
31.4 tumbler with 41.4 for 20.4
32.3 tumbler with 42.3 for 20.3
32.4 tumbler with 42.4 for 20.4
33.3 tumbler 43.3 for 20.3
33.4 tumbler with 43.4 for 20.4
34.3 tumbler with 44.3 for 20.3
34.4 tumbler with 44.4 for 20.4
35 spring-supporting projection on 31.3 (FIG. 2.3a)
36.3 normal tooth on 62.3 (FIG. 1.1a)
36.3′ reversed tooth on 62.3 (FIG. 1.3a)
36.4 normal tooth on 62.4 (FIG. 4.1a)
36.4′ reversed tooth on 62.4′ (FIG. 5.2a)
37.3a first outer flank of 36.3 and 36.3′ (FIGS. 1.1a-2.3b)
37.3i first inner flank of 36.3 and 36.3′ (FIGS. 1.1a-2.3b)
37.4 upper outer flank of 36.4 and 36.4′ (FIGS. 3-5.4b)
37.4′ lower outer flank of 36.4′ (FIGS. 3-5.4b)
38.3a second outer flank of 36.3 and 36.3′ (FIGS. 1.1a-2.3b)
38.3i second inner flank on 36.3 and 36.3′ (FIGS. 1.1a-2.3b)
38.4 upper inner flank of 36.4 (FIGS. 3-5.4b)
38.4′ lower inner flank on 36.4′ (FIGS. 3-5.4b)
41.3 control edge of 31.3
41.4 control edge of 31.4
42.3 control edge of 32.3
42.4 control edge of 32.4
43.3 control edge of 33.3
43.3 control edge of 34.3
44.4 control edge of 34.4
50.4 height position of 31.4, 32.4, 33.4 (FIGS. 4.1a-4.4a)
50.5 height position of 34.2, 34.3, 34.4 (FIGS. 5.1a-5.4a)
60.3 height position of 31.3, 32.3, 33.3 (FIGS. 1.1b-1.3b)
60.4 height position of 32.3, 33.3, 34.3 (FIGS. 2.1b-2.3b)
60.5 height position of 31.4, 32.4, 33.4 (FIGS. 4.1b-4.4b)
60.6 height position of 32.4, 33.4, 34.4 (FIGS. 5.1b-5.4b)
61.3 radial opening in 20.3
61.4 radial opening in 20.4
62.3 insert, comb (FIGS. 1.1a-2.3b)
62.4 insert, comb (FIGS. 3-5.4b)
63.3 outer end of 62.3 (FIG. 1.2a)
63.4 outer end of 62.4 (FIG. 3)
64.3 inner end of 62.3
64.4 inner end of 62.4
69 tongue on 34.3 (FIG. 2.1a)
70 window in 34.3 (FIG. 2.1a)
71.3 transverse plane of 20.3 (FIG. 1.2a)
71.4 transverse plane of 20.4 (FIGS. 4.1a, 4.1b)
72 distance between 36.4 and 71.4 (FIG. 4.1a)
72′ distance between 36.4′ and 71.4 (FIG. 4.2a)
73 upper end of 62.4 and 62.4′ (FIG. 6)
73′ lower end of 62.4 and 62.4′ (FIG. 3)
74.1 separating web on 31.4 (FIG. 4.1a)
74.2 separating web on 32.4 (FIG. 4.4a)
74.3 separating web on 33.4 (FIG. 4.3a)
74.4 separating web on 34.4 (FIG. 5.1a)
75.1 longitudinal midpoint of 31.4 (FIG. 4.1a)
75.2 longitudinal midpoint of 32.4 (FIG. 4.4a)
75.3 longitudinal midpoint of 33.4 (FIG. 4.3a)
75.4 longitudinal midpoint of 34.4 (FIG. 5.1a)
76.1 distance of 26.4 from 75.1 on 31.4 (FIG. 4.1a)
76.2 distance of 26.4 from 75.2 on 32.4 (FIG. 4.4a)
76.3 distance of 26.4 from 75.3 on 33.4 (FIG. 4.3a)
76.4 distance of 26.4 from 75.4 on 34.4 (FIG. 5.1a)
77 arrow of the pushing-down of 31.4 (FIG. 2.1b)

1. Lock cylinder consisting of a cylinder housing (10.3; 10.4) and a cylinder core (20.3; 20.4), which is supported (11) rotatably in the housing,
a key with a defined longitudinal profile being assigned to the core,
with a group of diametric shafts (23.3; 23.4) arranged in a row in the axial direction of the cylinder core (20.3; 20.4),
which hold plate-shaped tumblers (31.3-34.3; 31.4-33.4), the longitudinal edges (30.1; 30.2) of which are free to slide longitudinally along guide surfaces (21; 21) of the shaft (23.3), the tumblers also being spring-loaded (13.3; 13.4) in one of the two directions of their movement;
where each tumbler (31.3-34.3; 31.4-34.4) has a control edge (41.3-44.3; 41.4-43.4) in correspondence with the longitudinal profile of the key, each control edge being located at a defined height;
with a radial opening (61.3; 61.4) in the cylinder core (20.3; 20.4) and an insert (62.3; 62.4), which can be inserted into the opening;
the outer end (63.3; 63.4) of which insert does not project beyond the external contour of the cylinder core (20.3; 20.4) after its insertion, whereas the inner end (64.3; 64.4) engages in a cutout (36.3; 36.4) in the facing edge of the longitudinal plate edge (30.2) of the tumbler (31.3-34.3; 31.4-34.4);
as a result of which the spring-loaded tumblers (31.3-34.3; 31.4-34.4) are secured in the cylinder core (20.3; 20.4) before the core is installed in the housing (10.3; 10.4) and thus a loss-prevention function is provided; wherein
the insert consists of a comb-like body (comb 62.3; 62.4) with teeth (36.3, 36.3; 36.4, 36.4′), the inner ends (64.3; 64.4) of which have a profile with at least one pair of oppositely-facing flanks (flank pair 37.3a/38.3a, 37.31/38.3i; 37.4/38.4, 37.4′/38.4′);
whereas the cutouts (26.3; 26.4) in the tumblers (31.3-34.3; 31.4-34.4) have at least one pair of opposing flanks (opposing flank pair 27.3a/28.3a; 27.3i/28.3i; 27.4a/28.4a; 27.4i/28.4i), which are in different positions on the tumblers (31.3-34.3; 31.4-34.4) which have their control edges (41.3-44.3; 41.4-43.4) at different heights; in that
the flank pairs (37.3a/38.3a, 37.3i/38.3i; 37.4/38.4, 37.4′/38.4′) and the opposing flank pairs (27.3a/28.3a, 27.3i/28.3i; 27.4a/28.4a, 27.4i/28.4i) are arranged in such a way that, after the comb (62.3; 62.4) has been inserted and the key has been withdrawn, the control edges (41.3-44.3; 41.4-43.4) of at least two tumblers (31.3-34.3; 31.4-34.4) are at the same height (50.4, 60.3, 60.4; 50.5, 60.5, 60.6), which thus conceals the actual position of the control edges (41.3-44.3; 41.4-43.4),
when, in the rest position of the spring-loaded (13.3; 13.4) tumblers (31.3-34.3; 31.4-34.4), one of the flanks (38.3i) rests against one of the opposing flanks (28.3i) and/or
when, in an actuated position, after maximum displacement (77) of the tumblers (31.3-34.3; 31.4-34.4) by a lock-picking tool, the other flank (37.3i) meets the other opposing flank (27.3i).

2. Lock cylinder according to claim 1, wherein a set of different combs (62.3; 62.4) is assigned to a plurality of similar cylinder cores (20.4), the teeth (36.3, 36.3′; 36.4, 36.4′) of the combs being provided with different profiles.

3. Lock cylinder according to claim 1, wherein a set of different combs (62.3; 62.4) is assigned to a plurality of similar cylinder cores (20.4),
where the teeth (36.3, 36.3′; 36.4, 36.4′) of the combs have similar profiles and are arranged in either the normal or reversed position as desired and/or in different sequences on the comb (62.3; 62.4);
where, in order to increase the number of variations of the lock cylinder, one of these different combs (62,3; 62.4) is selected and inserted into one of the cylinder cores (20.3; 20.4) of uniform type.

4. Lock cylinder according to claim 1, wherein the profiles of all the teeth (36.3, 36.3′; 36.4, 36.4′) on the comb are of similar design.

5. Lock cylinder according to claim 1, wherein the opposing flanks (27.3a/28.3a; 27.3i/28.3i; 27.4a/28.4a; 27.4i/28.4i) of the cutouts (26.3; 26.4) are offset from each other in the height direction in the case of the tumblers (31.3-34.3; 31.4-34.4) with control edges (41.3-44.3; 41.4-43.4) in different positions.

6. Lock cylinder according to claim 1, wherein the inner ends (64.3; 64.4) of the teeth (36.3, 36.3′; 36.4, 36.4′) of the comb are convexly profiled in the radial direction with at least two pairs of flanks (37.3a/38.3a; 37.3i/38.3i; 37.4/38.4; 37.4′/38.4′), which are arranged in sequence in the direction of longitudinal movement and are at different heights; in that
the cutouts (26.3; 26.4) in the tumblers (31.3-34.3; 31.4-34.4) are concavely profiled in the radial direction and have sections which form at least two pairs of opposing flanks (27.3a/28.3a; 27.3i/28.3i; 27.4a/28.4a; 27.4i/28.4i), which are arranged in sequence in the direction of longitudinal movement and are offset from each other in the height direction.

7. Lock cylinder according to claim 1, wherein, although all of the teeth have essentially the same convex profile at their inner ends (64.3; 64.4), they are positioned in similar openings of the cylinder core (20.3; 20.4) in two different laterally reversed orientations (normal tooth 36.3; 3.64/reversed tooth 36.3′, 36.4′); and in that
the pairs of flanks (37.3a/38.3a, 37.3i/38.3i; 37.4/38.4, 37.4′/38.4′) of the normal teeth (36.3; 36.4) are laterally reversed with respect to those of the reversed teeth (36.3′; 36.4′).

8. Lock cylinder according to claim 7, wherein the normal tooth (36.3; 36.4) of the inserted comb (62.3; 62.4) is laterally reversed with respect to a transverse plane, which passes diametrically through the cylinder core (20.3; 20.4) in the area of the axis and extends transversely to the spring-loading (13.3; 13.4) of the tumblers (31.3-34.3; 31.4-34.4).

9. Lock cylinder according to claim 1, wherein the maximum point of the tooth profile (36.3, 36.3′) positioned in the cylinder core (20.3) lies essentially on the transverse plane (71.3) of the cylinder core (20.3).

10. Lock cylinder according to claim 9, wherein a tooth (36.3; 36.3′) of the comb has two pairs of flanks (37.3a/38.3a; 37.3i/38.3i), namely, an inner pair (37.3i/38.3i), which is closer to the transverse plane (71.3) of the cylinder core (20.3), and an outer pair (37.3a/38.3a), which is farther away from the transverse plane (71.3).

11. Lock cylinder according to claim 10, wherein the flanks of inner flank pair (37.3i/38.3i) are symmetrical to the transverse plane (71.3) of the cylinder core (20.3),
whereas the flanks (37.3a, 38.3a) of the outer flank pair are asymmetric with respect to the transverse plane (71.3).

12. Lock cylinder according to claim 1, wherein the flanks of the inner flank pair (37.3i/38.39) are parallel to the transverse plane (71.3), whereas
the flanks of the outer flank pair (37.3a/38.3a) are positioned at an angle to the transverse plane (71.3).

13. Lock cylinder according to claim 12, wherein the two outer flanks (37.3a, 38.3a) are angled in the same way as essentially mirror images of each other.

14. Lock cylinder according to claim 13, wherein the length of one of the outer flanks (37.3a) is different from that of the other outer flank (38.3a).

15. Lock cylinder according to claim 1, wherein the maximum points of the teeth (36.4, 36.4′) of the inserted comb (62.4) are located a certain distance away in the height direction from the transverse plane (71.4) of the cylinder core (20.4).

16. Lock cylinder according to claim 15, wherein the convex profile serving to control the tumbler (31.4-34.4) is positioned at one end of the tooth (36.4, 36.4′).

17. Lock cylinder according to claim 15, wherein the convex profile of the normal tooth (36.4) is an exact mirror image of the profile of the reversed tooth (36.4′) in the direction of the longitudinal movement of the tumblers (41.4-4.4).

18. Lock cylinder according to claim 15, wherein, although the convex profile of the teeth (36.4, 36.4′) has only one pair of flanks (37.4/38.4; 37.4′/38.4′), one of the flanks (37.4, 37.4′) has a form different from that of the other flank (38.4, 38.4′).

19. Lock cylinder according to claim 18, wherein one of the flanks (38.4, 38.4′) is essentially parallel to the transverse plane (71.4) of the cylinder core (20.4), whereas the other flank (47.4, 47.4′) forms an angle with that plane.

20. Lock cylinder according to claim 15, wherein the normal teeth (36.4) and the reversed teeth (36.4′) are arranged in an alternating sequence in the successive shafts (23.4) of the cylinder core (20.4).

21. Lock cylinder according to claim 20, wherein the comb (62.3, 62.4), has an even number of teeth (36.4; 36.4′); and in that
the comb (62.4) can be inserted into the cylinder core (20.4) with either one of two different orientations, one the reverse of the other,
where the comb (62.4) begins with a normal tooth (36.4) when inserted with one of the two orientations, whereas a reversed tooth (36.4′) is at the front of the comb (62.4) when the comb is inserted with the other orientation.

22. Lock cylinder according to claim 1, wherein, although the cutouts (26.3; 26.4) in the individual tumblers (31.3-34.3; 31.4-34.4) are of similar design, they have different dimensions as a function of the height position of the control edge (41.3-44.3; 41.4-44.4).

23. Lock cylinder according to claim 23, wherein the cutouts (26.3) are designed with two steps and thus produce two pairs of opposing flanks (27.3a-28.3i) at different depths,
namely, an inner pair of opposing flanks (27.3i, 28.3i) on the lower step of the cutout (26.3) and an outer pair (27.3a, 28.3a) on the upper step.

24. Lock cylinder according to claim 23, wherein the cutout (26.4) has a separating web (74.1-74.4), and in that
as a function of the height position of the control edge (41.4-44.4) of the associated tumbler (31.4-44.4), the lengths or positions (76.1-76.4) of the cutouts (26.4) and/or the positions of the webs (74.1-74.4) in the cutouts and/or the lengths of the .webs are different.

25. Lock cylinder according to claim 24, wherein the separating web (74.1-74.4) is positioned essentially at the longitudinal midpoint (75.1-75.4) of the cutout (26.4).

26. Lock cylinder according to claim 24, wherein the cutouts (26.4) have two pairs of opposing flanks (27.4a-28.4i),
where one of the pairs of opposing flanks (27.4i, 28.4i) is formed by the two terminal edges of the separating web (74.1-74.4), which form inner opposing flanks (27.4i, 28.4i), which face away from each other;
whereas the other pair of opposing flanks (27.4a, 28.4a) is formed by the two inner edges at the outer end of the cutout (26.4), which form outer opposing flanks (27.4a, 28.4a), which face each other.

27. Lock cylinder according to claim 23, wherein the inner opposing flanks (27.4i, 28.4i) have a design different from that of the outer opposing flanks (27.4a, 28.4a).

28. Lock cylinder according to claim 27, wherein the inner opposing flanks (27.4i, 28.4i) are essentially parallel to the transverse plane (71.4) of the cylinder core (20.4), whereas the outer opposing flanks (27.4a, 28.4a) are at a certain angle to the transverse plane (71.4).

29. Lock cylinder according to claim 28, wherein the angles of the two outer opposing flanks (27.4a, 28.4a) are essentially exact mirror images of each other.

30-44. (canceled)
